(19) United States
(12) Patent Application Publication
(10) Pub. No.: US 2024/0097121 A1
(43) Pub. Date: Mar. 21, 2024

(54) NEGATIVE ELECTRODE MATERIAL AND PREPARATION METHOD THEREFOR, NICKEL-METAL HYDRIDE SECONDARY BATTERY USING THE NEGATIVE ELECTRODE MATERIAL

(71) Applicant: GP Technology & Innovation Limited, NEW TERRITORIES (HK)

(72) Inventors: Jean NEI, NEW TERRITORIES, HONG KONG (HK); Zhitao CHEN, NEW TERRITORIES, HONG KONG (HK); Nian LIU, NEW TERRITORIES, HONG KONG (HK); Mingde WANG, New Territories (HK); Shuang ZHANG, NEW TERRITORIES, HONG KONG (HK)

(21) Appl. No.: 17/963,792

(22) Filed: Oct. 11, 2022

(30) Foreign Application Priority Data
Sep. 16, 2022 (CN) 202211126298.1

(51) Int. Cl. H01M 4/38; H01M 4/04; H01M 4/36; H01M 10/36

(52) U.S. Cl. CPC H01M 4/38; H01M 4/0471; H01M 4/366; H01M 10/36; H01M 2004/027

(57) ABSTRACT

The present invention relates to a negative electrode material comprising a hydrogen storage alloy and a coating layer on a surface of the hydrogen storage alloy. Based on the mass of the negative electrode active material, a content of the coating layer is no less than 2 wt %. The coating layer comprises a component shown by a general formula LnFₓ, wherein Ln is one element selected from the group consisting of La, Ce, Pr, Nd, Pm, Sm, Eu, Gd, Tb, Dy, Ho, Er, Tm, Yb, Lu, Y, and Sc. The present invention also relates to a preparation method for the above-described negative electrode material. The present invention also relates to a nickel-metal hydride secondary battery using this negative electrode material.

### TECHNICAL FIELD

The present invention relates to a technical field of nickel-metal hydride secondary battery, particularly relates to a negative electrode material, a preparation method for the negative electrode material, as well as a nickel-metal hydride secondary battery using the negative electrode material.

### BACKGROUND

Nickel-metal hydride secondary battery has advantages including good low-temperature performance, high overcharging/overdischarging tolerance, excellent safety, being environmental friendly, etc. and is widely used in fields such as portable electronic products, small electric tools, and the like. Current nickel-metal hydride secondary battery uses nickel hydroxide as the positive electrode material and a hydrogen storage material as the negative electrode material. During charge, nickel hydroxide is oxidized at the positive electrode, and protons resulted from water splitting at the negative electrode combine with the hydrogen storage material to form metal hydride; during discharge, the process is just the opposite.

The hydrogen storage material has greater effects on the performance of the nickel-metal hydride battery as negative electrode material thereof. Hydrogen storage materials can be simple substance capable of reacting exothermically with hydrogen, such as platinum group elements, lanthanide group elements and alkali earth metal elements capable of forming stable compounds with hydrogen, or an alloy formed of the above-described metals and other metals. The electrochemical hydrogen absorption and desorption reactions of the electrode formed of the hydrogen storage material during charge and discharge of the nickel-metal hydride battery are mainly related to the bulk phase property of the hydrogen storage material, the electrochemical reaction on the surface of the electrode, and the interface property among three phases of electrode/electrolyte solution/gas. Therefore, the performance of the nickel-metal hydride secondary battery can be enhanced by improving the properties of the hydrogen storage material (such as corrosion resistance, electrical conductivity, and electrocatalytic activity, etc.) through surface modification.

Conventional hydrogen storage materials are divided into the following categories (wherein, A represents the metal element capable of reacting exothermically with hydrogen, and B is other types of metal elements):
AB₅ type (such as LaNi₅, CaNi₅);
AB₂ type (such as MgZn₂, ZrNi₂);
AB type (such as TiNi, TiTe);
A₂B type (such as Mg₂Ni, Ca₂Fe); and
other types (such as atomic cluster).

Existing technical solutions for improving performances of the hydrogen storage material are mainly formulation modification, doping, and alloy surface treatment, aiming at realizing the following purposes:
appropriately modifying the hydrogen-metal bonding strength, so that the hydrogen absorption and desorption reactions are relatively easy to occur;
improving the hydrogen absorption and desorption characteristics and the relationship between the two (plateau pressure and hysteresis), the range of equilibrium area (plateau length), change of equilibrium pressure during hydrogen absorption (slope factor), etc.; and
enhancing the physical and chemical stabilities of the hydrogen storage material.

Wherein, commonly used surface treatment methods for the hydrogen storage material mainly include alkaline treatment, acid treatment, fluorination treatment, surface coating, and the like. A sublayer rich in nickel or a modified surface layer with good corrosion resistance and conductivity generated by removing the native oxide layer on the alloy surface can enhance the conductivity and anti-corrosion capability of the alloy. Wherein, a commonly used doping method for the hydrogen storage material is directly adding an electrically conductive material (for example, carbon nanotube, acetylene black, graphene, etc.) and/or a material containing one or more rare earth elements (La, Ce, Pr, Nd, Pm, Sm, Eu, Gd, Tb, Dy, Ho, Er, Tm, Yb, Lu, Y, and Sc) into the electrode material by mechanical mixing to obtain a composite electrode material.

However, although the above-described technical solutions can promote cycling and high-temperature performance stabilities, other performances (such as capacity, high-rate discharge, and low-temperature performance) are generally sacrificed simultaneously. The problem of poor stability of the hydrogen storage material at high temperature is accelerated passivation and corrosion. It should be noted that, unless otherwise specified, the high temperature stated in the present invention is a temperature no less than 50° C.

### SUMMARY

One of the purposes of the present invention is to provide a negative electrode material of which cycling performance as well as physical and chemical stabilities at high temperature are enhanced, and whose room-temperature high-rate discharge and low-temperature discharge performances are also improved.

Another purpose of the present invention is to provide a method for preparing the above-described negative electrode material.

A further purpose of the present invention is to provide a negative electrode material for nickel-metal hydride secondary battery with comparable properties but improved cycling performance.

In order to achieve the above-described purposes, the present invention provides the following negative electrode material, which comprises a hydrogen storage alloy and a coating layer on the surface of the hydrogen storage alloy. Based on the mass of the negative electrode active material, the content of the coating layer is no less than 2 wt %. The coating layer comprises a component shown by a general formula LnFₓ, wherein, Ln is at least one element selected from the group consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), and scandium (Sc).

Hydrogen storage alloy is an alloy capable of storing and releasing hydrogen and used as the negative electrode active material, and the content of the hydrogen storage alloy in the negative electrode affects the of the negative electrode. In order to balance the capacity and stability of the negative electrode, based on the mass of the negative electrode active material, the content of the coating layer is preferably 2 wt %-4 wt %.

Thickness of the coating layer is 0.1-1000 nm. If the thickness of the coating layer is less than 0.1 nm, hydrogen storage alloy could be exposed due to the incomplete coating of the coating layer; and if the thickness of the coating layer is more than 1000 nm, the capacity of the negative electrode may be significantly reduced.

In order to balance the cycling performance and stability of the negative electrode material, the coating layer preferably comprises LaF₃.

In order to balance the high-rate discharge performance and stability of the negative electrode material, the hydrogen storage alloy is preferably AB₅ type; more preferably, in a crystal structure of the hydrogen storage alloy of AB₅ type, A site thereof contains X element, and B site thereof contains Ni element and Y element, wherein, X is at least one element selected from the group consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), calcium (Ca), strontium (Sr), scandium (Sc), yttrium (Y), titanium (Ti), zirconium (Zr), and hafnium (Hf), and Y is at least one element selected from the group consisting of manganese (Mn), cobalt (Co), vanadium (V), niobium (Nb), tantalum (Ta), chromium (Cr), molybdenum (Mo), iron (Fe), aluminum (Al), gallium (Ga), zinc (Zn), tin (Sn), indium (In), copper (Cu), silicon (Si), phosphorus (P), and boron (B). Based on the current understanding, AB₅ type of hydrogen storage alloy consists of mixed rare earth elements and nickel, has a stronger reductivity, and is easily oxidized to form a metal oxide with poor electrical conductivity in air and aqueous solution, so that electrochemical performance of the material deteriorates. Also, during cycling, alloy particles are gradually pulverized and separated from the current collector due to repeated hydrogen absorption and desorption, causing the decay in battery capacity and acceleration to end of battery life. In the negative electrode material provided by the present invention, the coating layer can significantly inhibit the oxidation and pulverization of hydrogen storage alloy, so using this negative electrode material is effective in enhancing the performance and lifetime of the nickel-metal hydride battery.

In order to balance the low-temperature discharge performance and stability of the negative electrode material, the amount of hydrogen storage alloy particles with a particle diameter no more than P is preferably no more than 10 wt % of all hydrogen storage alloy particles, where P is the particle diameter no more than half of average particle diameter. Based on the current understanding, if the content of the smaller hydrogen storage alloy particles reduces, the surface area for reaction reduces, therefore the low-temperature discharge characteristic of the battery reduces, but self-discharge of the battery can be inhibited. It is unexpectedly found that, in order to inhibit self-discharge of the battery and enhance the low-temperature discharge performance, the particle diameter distribution should be adjusted so that particles with a particle diameter no more than P is no more than 10 wt %.

In addition, the present invention also provides a method for preparing the above-described negative electrode material, includes the following steps:
a step of dissolving polyvinylpyrrolidone (PVP) in deionized water to obtain a first solution;
a step of dissolving at least one salt containing an Ln element in the first solution to obtain a second solution;
a step of pre-dissolving an inorganic fluoride salt in deionized water to obtain a third solution;
a step of immersing a hydrogen storage alloy in the second solution to obtain a first mixture;
a step of adding the third solution into the first mixture to obtain a second mixture;
a step of subjecting the second mixture to a heating treatment to obtain a powder;
and a step of subjecting the powder to a drying treatment and then a calcining treatment.

In the preparation method provided by the present invention, the content of the coating layer in the negative electrode material is controlled by adjusting the ratio of the hydrogen storage alloy to the salt containing Ln element to NH₄F.

Preferably, the inorganic fluoride salt is NH₄F or NaF.

In addition, the present invention also provides a nickel-metal hydride secondary battery, which has a container and an electrode assembly contained in the container together with an alkaline electrolyte in a sealed state, wherein the electrode assembly is composed of a positive electrode and a negative electrode separated by a separator, and the negative electrode contains the above-described negative electrode material. The nickel-metal hydride secondary battery can be in the form of a button cell, pouch cell, cylindrical cell, or prismatic cell.

Compared to the prior art, the technical solutions of the present invention have at least the following beneficial effects:
1. in the negative electrode material, the coating layer is uniformly coated on the hydrogen storage alloy, and the coating layer is tightly connected to the hydrogen storage alloy, thereby inhibiting separation or delamination of the coating layer from the hydrogen storage alloy during charge/discharge;
2. by including this type of negative electrode material in the negative electrode of the nickel-metal hydride secondary battery, high-temperature stability, low-temperature discharge characteristic, cycling performance, and high-rate discharge performance are improved; and
3. for the hydrogen storage alloy, one of the most common capacity degradation mechanisms is alloy passivation/corrosion in an alkaline electrolyte, and a high-temperature environment may accelerate this reaction and consequently causes earlier cell failure. While the hydrogen storage alloy's passivation products (metal oxide or hydroxide) impede electrochemical reaction, the leached-out elements from hydrogen storage alloy in the alkaline electrolyte, such as Al, Mn, and Co, not only affect the hydrogen storage alloy's capability, but they could also travel and cause the degradation of CoOOH coating at the surface of Ni(OH)₂ particles, pollute β-Ni(OH)₂ to form the irreversible γ-NiOOH/α-Ni(OH)₂, and precipitate in the separator and cause micro-shorts. The negative electrode material provided by the present invention may protect the hydrogen storage alloy from being passivated and corroded during cycling and storing at high temperature by forming an anti-corrosion coating layer on the surface of the hydrogen storage alloy. A rare earth fluoride in the coating layer also increases specific surface area, which is beneficial for preventing pulverization (capacity retention is enhanced after cycling) and hydrogen gas adsorption (high-rate discharge performance is enhanced).

### DESCRIPTION OF DRAWINGS

Attached drawings further describe the present invention. However, Examples in drawings do not cause any limitation to the present invention.

FIG. 1 is Transmission Electron Microscope (TEM) photographs for the hydrogen storage alloy;

FIG. 2 is a Scanning Electron Microscope (SEM) photograph for the hydrogen storage alloy;

FIG. 3 is X-ray Photoelectron Spectroscopy (XPS) spectrums for the hydrogen storage alloy;

FIG. 4 is TEM photographs of the negative electrode material in Example 1;

FIG. 5 is TEM photographs of the negative electrode material in Example 2;

FIG. 6 is SEM photograph of the negative electrode material in Example 2;

FIG. 7 is XPS spectrums of the negative electrode material in Example 2;

FIG. 8 is figures for charge/discharge cycling performance at room temperature; and FIG. 9 is figures for discharge rate capability at room temperature (in the Figure, the solid line is obtained at the charge/discharge cycle where the half-cell demonstrates its maximum capacity, and the dotted line is obtained at charge/discharge cycle 50).

### DETAILED DESCRIPTION OF EMBODIMENTS

It should be understood that specific Examples described herein are only for explaining the present invention but not for limiting the present invention.

A nickel-metal hydride secondary battery of the present invention is now described. As a nickel-metal hydride secondary battery applicable in the present invention, there is no particular limitation.

In one Example, nickel-metal hydride secondary battery has a cylindrical can with a top opening as a container. The can is electrically conductive, and its bottom wall acts as the negative terminal. The top opening of cylindrical can is sealed with a cap. The cap comprises a cover plate and a terminal, providing the battery with a positive terminal after sealing the can with it. The cover plate is a circular component and electrically conductive. Within the cover plate, there is also an insulating gasket. By caulking between the edge of top opening and cover plate, the insulating gasket is fixed onto the opening edge. That is, the cover plate and insulating gasket together can provide an airtight seal. The can contains an alkaline electrolyte and an electrode assembly. The electrode assembly is a sandwich composed of a positive electrode sheet and a negative electrode sheet with a separator sheet in between, which is then wound into a jellyroll with the negative electrode being the outermost layer. The negative electrode is in direct contact with the inner wall of can (physically and electrically). The positive electrode is connected to a positive electrode pin (physically and electrically), which is then connected to the cover plate on the cap (physically and electrically). Therefore, the positive terminal and the positive electrode are electrically connected to each other through the connection between the positive electrode pin and cover plate. In addition, there is a circular insulating component between the cover plate and the electrode assembly to avoid the connection between the negative electrode and cover plate, and the positive electrode pin extends through a slit provided in the insulating component for positive electrical connection. There is also a circular insulating component between the electrode assembly and the bottom of can to avoid the connection between the positive electrode and can.

In one Example, the nickel-metal hydride secondary battery comprises an alkaline electrolyte containing NaOH as the main solute. Most of the alkaline electrolyte is maintained in the electrode assembly of the nickel-metal hydride secondary battery to enable the charge/discharge reactions between the positive and negative electrodes. The alkaline electrolyte containing NaOH as the main solute may also contain at least one of KOH and LiOH. Herein, the amount of NaOH is more than those of KOH and LiOH to inhibit self-discharge.

In one Example, the separator used in the nickel-metal hydride secondary battery is, for example, a material obtained by imparting non-woven fabric made of polyamide fiber or non-woven fabric made of polyethylene, polypropylene, or other polyolefin with a hydrophilic functional group. Specifically, sulfonated non-woven fabric composed of polyolefin fiber is preferably used. Herein, non-woven fabric is imparted with sulfonyl group by treating the non-woven fabric with an acid containing sulfuric acid group (such as sulfuric acid, fuming sulfuric acid, etc.). Sulfonation treatment not only can increase hydrophilicity of the separator fabric, it can only inhibit self-discharge in the battery.

In one Example, the positive electrode of the nickel-metal hydride secondary battery is composed of an electrically conductive and porous substrate and a positive electrode mixture held within and on the surface of the porous substrate. Positive electrode substrate can be nickel-plated mesh-like, sponge-like, or fiber-like metal body or nickel foam. The positive electrode mixture contains positive electrode active material particles, electrically conductive material, positive electrode additive, and adhesive. The adhesive bonds the positive electrode active material particles, electrically conductive material, and positive electrode additive together and also bonds the positive electrode mixture onto the positive electrode substrate. Adhesive can be carboxylmethyl cellulose, methyl cellulose, polytetrafluoroethylene dispersion, hydroxypropyl cellulose dispersion, or the like. Positive electrode active material particles are nickel hydroxide particles or higher-valence nickel hydroxide particles. In addition, at least one of zinc, magnesium, and cobalt is preferably coprecipitated in these nickel hydroxide particles. Electrically conductive material can be one or more selected from the group consisting of cobalt compounds (such as cobalt oxide, cobalt hydroxide, etc.) and cobalt. The electrically conductive material is added to the positive electrode mixture as needed and in the forms of powder additive or coating on the surface of the positive electrode active material particles. In order to improve the characteristic of the positive electrode, the positive electrode additive is appropriately selected as needed for addition. Positive electrode additive is usually yttrium oxide, zinc oxide, and scandium oxide.

In one Example, the negative electrode of the nickel-metal hydride secondary battery is composed an electrically conductive substrate and a negative electrode mixture held within the substrate. The negative electrode substrate can be made of metal sheet distributed with through-holes, for example, punched metal sheet. The negative electrode mixture not only fills in the through-holes of the negative electrode substrate but also maintains on both sides of the negative electrode substrate. The negative electrode mixture contains the negative electrode material provided by the present invention, electrically conductive material, and adhesive. Additionally, negative electrode additive may also be added as needed. The adhesive bonds the negative electrode material provided by the present invention and electrically conductive material together and also bonds the negative electrode mixture onto the negative electrode substrate. Adhesive can be hydrophilic polymer, hydrophobic polymer, etc. Electrically conductive material can be carbon black, graphite, nickel powder, or the like.

The negative electrode material provided by the present invention comprises a hydrogen storage alloy and a coating layer on the surface of the hydrogen storage alloy. Wherein the hydrogen storage alloy has no particular limitation, but the AB₅ type is preferably used. In the crystal structure of the hydrogen storage alloy of AB₅ type having, A site thereof contains X element, and B site thereof contains Ni element and Y element, wherein, X is at least one element selected from the group consisting of La, Ce, Pr, Nd, Pm, Sm, Eu, Gd, Tb, Dy, Ho, Er, Tm, Yb, Lu, Ca, Sr, Sc, Y, Ti, Zr, and Hf, and Y is at least one element selected from the group consisting of Mn, Co, V, Nb, Ta, Cr, Mo, Fe, Al, Ga, Zn, Sn, In, Cu, Si, P and B. Furthermore, in order to achieve better cycle life performance in the nickel-metal hydride secondary battery, Al and Mn are preferably selected for B site.

The hydrogen storage alloy of AB₅ type may be obtained by, for example, the following method. Firstly, raw materials in elemental form are weighed and mixed according to the predetermined composition. The mixture is melted, for example, in a high-frequency induction melting furnace under an inert gas atmosphere and then cooled down to form an ingot. Heat treatment is performed on the obtained ingot at 900-1200° C. in an inert gas atmosphere for 5-24 hours. Thereafter, the ingot is cooled to room temperature and then mechanically pulverized to obtain the hydrogen storage alloy powder. The particle distribution for the hydrogen storage alloy powder can be adjusted by altering the pulverization method/condition.

It should be noted that, XPS analysis on materials fabricated in Examples by means of Thermo K-Alpha XPS were performed in several steps and described below:
using an appropriate amount of sample powder to fill the hole to make a relatively smooth surface on the sample holder;
placing the sample holder on the load lock, which is then pumped down for 30 minutes;
transferring the sample holder from the load lock to the analysis chamber with a pressure lower than 4×10⁻⁷ mbar;
before performing the XPS experiment, fine-2.7tuning the X, Y, and Z focus positions;
selecting La, Ni and F for high-resolution, element-specific scans; and
using Thermo Avantage software for data processing.

### Comparative Example 1

The present Comparative Example provides a preparation method of nickel-metal hydride secondary battery, which includes the following steps:

1. Positive Electrode Fabrication

100 parts by weight of positive electrode active material powder composed of nickel hydroxide particles (the surface of the nickel hydroxide particles is coated with a conductive cobalt oxyhydroxide layer, and the coating amount is 1.0 parts by weight in the active material) is mixed with 0.5 parts by weight of zinc oxide, 0.5 parts by weight of yttrium oxide, and 40 parts by weight of HPC dispersion to form a positive electrode mixture slurry. The positive electrode mixture slurry is filled into a nickel foam sheet substrate. After drying, roll pressing of positive electrode mixture-filled substrate is performed. The pressed positive electrode is then cut into a specified dimension. Thereby, AA-sized positive electrodes are obtained.

2. Hydrogen Storage Alloy Fabrication

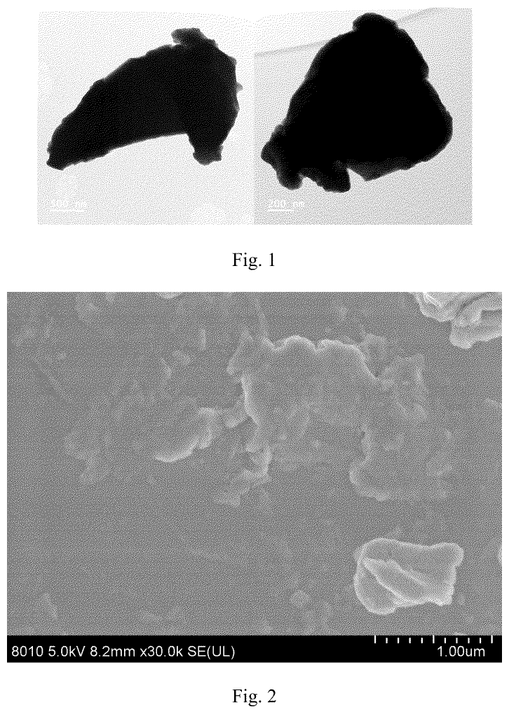

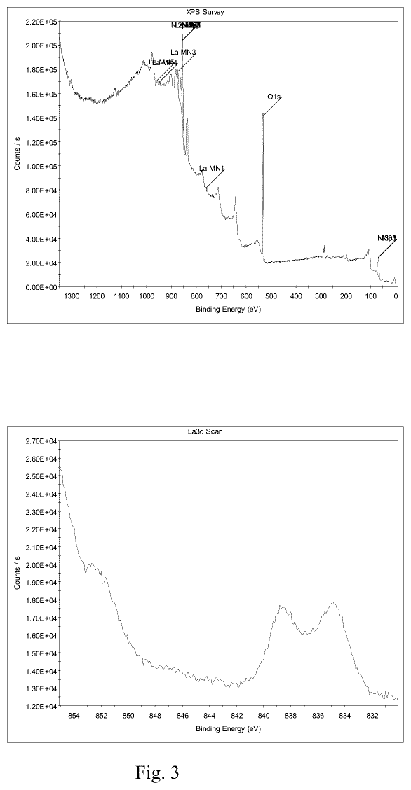

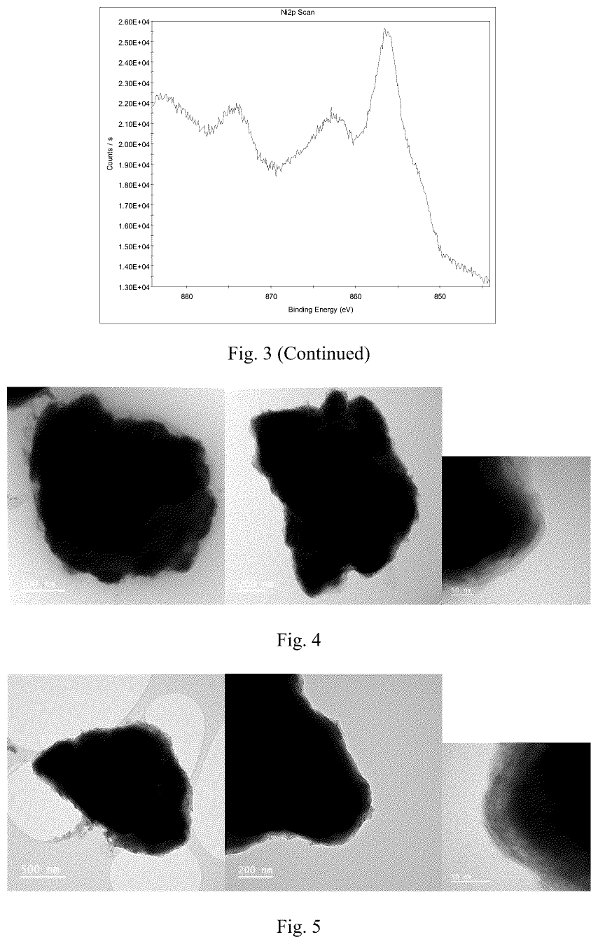

The hydrogen storage alloy is AB₅ type, specifically La_{9.2}Ce_{6.0}Pr_{0.2}Nd_{0.7}Zr_{0.3}Ni_{73.0}Mn_{5.9}Al_{4.6}. Raw materials in the elemental form are weighed according to the designed composition and mixed. The obtained mixture is melted by means of a high frequency induction melting furnace in an argon atmosphere, and the melt is poured into a casting mold and cooled to room temperature to form an alloy ingot. The as-cast alloy ingot is then heat treated at 1080° C. for 5 hours in a tube furnace in an argon atmosphere to achieve better homogenization. After the hydrogen storage alloy ingot is cooled to room temperature after the heat treatment, it is mechanically pulverized in an argon atmosphere, and the pulverized product is passed through a 200-mesh sieve to obtain a −200-mesh hydrogen storage alloy powder. Herein, the powder is analyzed by means of TEM, and the obtained result is shown in FIG. 1; the powder is analyzed by means of SEM, and the obtained result is shown in FIG. 2; and the powder is analyzed by means of Thermo K-Alpha XPS, and the obtained result is shown in FIG. 3.

3. Negative Electrode Fabrication

100 parts by weight of the obtained hydrogen storage alloy powder, 0.4 parts by weight of sodium polyacrylate, 0.1 parts by weight of carboxylmethyl cellulose, 2.5 parts by weight of styrene-butadiene copolymer, 1.0 part by weight of carbon black, and 30 parts by weight of water are mixed to form a negative electrode mixture slurry. The negative electrode mixture slurry is uniformly coated in a constant thickness on both sides of a nickel-plated punched metal sheet substrate, which has a thickness of 40 μm. After drying, roll pressing of negative electrode mixture-filled substrate is performed to enhance the amount of active material per unit volume. The pressed negative electrode is then cut into a specified dimension to prepare AA-sized negative electrodes.

4. Nickel-Metal Hydride Secondary Battery Assembly

A sandwich composed of a positive electrode sheet and a negative electrode sheet with a separator sheet in between is wound into a jellyroll to make an electrode assembly. Separator used in the electrode assembly is a sulfonated non-woven fabric made of polypropylene fiber. The above-described electrode assembly is contained within a cylindrical can, and 2.2 g of the alkaline electrolyte (containing KOH, NaOH, and LiOH) is injected into the can. Then, the top opening of the can is sealed with a cap to complete the assembly of an AA-sized nickel-metal hydride secondary battery with a nominal capacity of 2500 mAh.

5. Initial Activation

After the obtained battery is charged at a current of 0.1C for 16 hours at 25° C., it is discharged at a current of 0.2C until a cut-off voltage of 0.5 V. This process is repeated twice. At this time, the nickel-metal hydride secondary battery is in a usable state.

### Comparative Example 2

The present Comparative Example provides a preparation method of half-cell for electrochemical testing, which includes the following steps:

1. Negative Electrode Fabrication

40 mg of the negative electrode material and 160 mg of the nickel powder are mixed uniformly to form a mixture. The mixture is transferred into a mold pressed into a cake-shaped negative electrode (with a diameter of 10 mm) on a fully automatic presser with the settings of upper limit for pressure of 3.0 t, lower limit for pressure of 2.7 t, pressing time of 1 min, and mold diameter of 10 mm. The cake-shaped negative electrode is then pressed onto a piece of nickel foam on a fully automatic presser with the settings of upper limit for pressure of 1.0 t, lower limit for pressure of 0.7 t, pressing time of 30 s, and mold diameter of 20 mm.

2. Positive Electrode Fabrication

A commercially available sintered positive electrode suitable for pairing with the negative electrode is employed in the half-cell setup.

3. Half-Cell Assembly

A piece of grafted polypropylene/polyethylene separator is folded in half and used to sandwich the negative electrode, so both sides of the negative electrode are in contact with the separator. Then, the negative electrode wrapped by the separator is sandwiched with two sintered positive electrodes (the two sintered positive electrodes are connected by a nickel tab strip) to form the electrode assembly. The electrode assembly is placed into an acrylic cell holder. The acrylic cell holder containing the electrode assembly is placed into a 100 ml container, which is then filled with 30 wt % KOH solution, thus obtaining a half-cell in a flooded cell configuration.

4. Half-Cell Testing

Electrochemical testing is performed on the negative electrode (working electrode) with the sintered positive electrode as the counter electrode and reference electrode. Before the tests, two activations must be performed. For each cycle, the half-cell is charged at a current density of 100 mA/g for 5 hours in the first step; in the second step, after finishing charging, the half-cell is discharged at a current density of 100 mA/g until reaching a cut-off voltage of 0.9 V; and in the third step, the half-cell is discharged at a current density of 24 mA/g until reaching the cut-off voltage of 0.9 V.

It should be noted that the negative electrode material used in the present Comparative Example is the hydrogen storage alloy in Comparative Example 1, i.e. La_{9.2}Ce_{6.0}Pr_{0.2}Nd_{0.7}Zr_{0.3}Ni_{73.0}Mn_{5.9}Al_{4.6}.

### Comparative Example 3

The present Comparative Example provides a preparation method of half-cell for electrochemical testing. The difference between the half-cell provided by the present Comparative Example and the half-cell provided by Comparative Example 2 is only that the half-cell of the present Comparative Example uses a negative electrode material comprising the hydrogen storage alloy in Comparative Example 1 and a nickel coating layer on the surface of the hydrogen storage alloy particles.

Preparation for the negative electrode material of the present Comparative Example includes the following steps:

In the first step, the hydrogen storage alloy powder is immersed in Solution I (comprising 0.05 mol/L of NiSO₄ and 0.05 mol/L of N₂H₄·H₂SO₄) and stirred for 5 minutes;

In the second step, Solution II (comprising 0.64 g/L of NaBH₄ and 0.2 g/L of NaOH) is added into Solution I. The mixture is stirred slowly for 20 minutes; and

In the third step, the mixture is subjected to filtration, and the collected solid particles are dried at 60° C. in vacuum to obtain the negative electrode material.

### Comparative Example 4

The present Comparative Example provides a preparation method of half-cell for electrochemical testing. The difference between the half-cell provided by the present Comparative Example and the half-cell provided by Comparative Example 2 is only that the half-cell of the present Comparative Example uses a negative electrode material that is the fluorination-treated hydrogen storage alloy (La_{9.2}Ce_{6.0}Pr_{0.2}Nd_{0.7}Zr_{0.3}Ni_{73.0}Mn_{5.9}Al_{4.6}).

Preparation for the negative electrode material of the present Comparative Example includes the following steps:
In the first step, the hydrogen storage alloy powder is immersed in an aqueous solution containing KF and HF at 50° C., and then KBH₄ is added into the solution;
In the second step, disappearance of hydrogen bubbles is regarded as the end of the fluorination treatment; and
In the third step, the hydrogen storage alloy powder after the fluorination treatment is washed by deionized water and ethanol, and then it is dried at 50° C. in vacuum, to obtain the negative electrode material.

### Example 1

The present Example provides a preparation method of half-cell for electrochemical testing. The difference between the half-cell provided by the present Example and the half-cell provided by Comparative Example 2 is only that the negative electrode material used in the present Example comprises the hydrogen storage alloy (La_{9.2}Ce_{6.0}Pr_{0.2}Nd_{0.7}Zr_{0.3}Ni_{73.0}Mn_{5.9}Al_{4.6}) and a LaF₃ coating layer on the surface of the hydrogen storage alloy particles, and based on the mass of the negative electrode active material, the content of the coating layer is 2 wt %. Herein, the negative electrode material used in the present Example is analyzed by means of TEM, and the obtained result is shown in FIG. 4.

Preparation for the negative electrode material of the present Example includes the following steps:
In the first step, the hydrogen storage alloy powder, PVP (MW≈55000), La(NO₃)₃·6H₂O (MW=433.01 g/mol), and NH₄F (MW=37.04 g/mol) are weighed. It should be noted that each 1 g of the hydrogen storage alloy powder corresponds to 0.01 g of PVP, 0.04421 g of La(NO₃)₃·6H₂O, and 0.01134 g of NH₄F;
In the second step, PVP is dissolved in 10 ml of deionized water in a beaker and stirred for 10 minutes at 500 RPM to obtain Solution I;
In the third step, La(NO₃)₃·6H₂O is dissolved in Solution I to obtain Solution II;
In the fourth step, NH₄F is dissolved in 1 ml of deionized water in a small vial to obtain Solution III;
In the fifth step, Solution II is heated to 80° C. using a hot plate and stirred at 300 RPM. The hydrogen storage alloy powder is immersed in Solution II to obtain Mixture I;
In the sixth step, Solution III is added into Mixture I drop by drop by a pipette to obtain Mixture II;
In the seventh step, Mixture II is continuously stirred at 80° C. until the liquid in Mixture II is completely evaporated to obtain a powder; and
In the eighth step, the obtained powder is dried at 80° C. for 12 hours in vacuum, and then it is calcinated at 100° C. for 1 hour under an argon environment to obtain the negative electrode material.

### Example 2

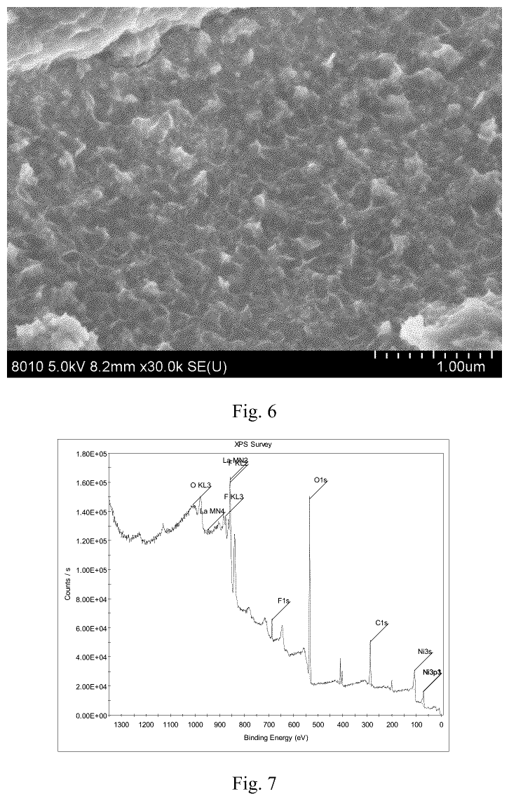

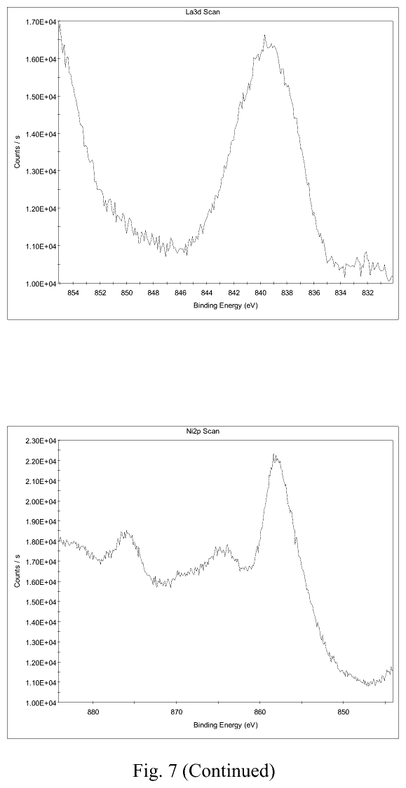

The present Example provides a preparation method of half-cell for electrochemical testing. The difference between the half-cell provided by the present Example and the half-cell provided by Example 1 is only that the negative electrode material used in the present Example comprises the hydrogen storage alloy (La_{9.2}Ce_{6.0}Pr_{0.2}Nd_{0.7}Zr_{0.3}Ni_{73.0}Mn_{5.9}Al_{4.6}) and a LaF₃ coating layer on the surface of the hydrogen storage alloy particles, and based on the mass of the negative electrode active material, the content of the coating layer is 4 wt %. Herein, the negative electrode material used in the present Example is analyzed by means of TEM, and the obtained result is shown in FIG. 5; the negative electrode material used in the present Example is analyzed by means of SEM, and the obtained result is shown in FIG. 6; and the negative electrode material used in the present Example is subjected to XPS analysis by means of Thermo K-Alpha XPS, and the obtained result is shown in FIG. 7.

From the comparison of FIG. 1, FIG. 4, and FIG. 5, the coating layer uniformly covers the hydrogen storage alloy particles in the negative electrode material provided by the present invention. From the comparison of FIG. 6 and FIG. 2, the hydrogen storage alloy with a LaF₃ coating demonstrates a rougher surface compared to the bare hydrogen storage alloy, or in other words, has a larger specific surface area. From the comparison of FIG. 3 and FIG. 7, bare hydrogen storage alloy does not contain element F on the particle surface, but the hydrogen storage alloy in the negative electrode material provided by the present invention contains element F on the particle surface.

The difference between the preparation method for the negative electrode material in the present Example and the preparation method for the negative electrode material in Example 1 is only that each 1 g of the hydrogen storage alloy corresponds to 0.01 g of PVP, 0.08840 g of La(NO₃)₃·6H₂O, and 0.02238 g of NH₄F.

### Example 3

The present Example provides a preparation method of half-cell for electrochemical testing. The difference between the half-cell provided by the present Example and the half-cell provided by Example 1 is only that the negative electrode material used in the present Example comprises the hydrogen storage alloy (La_{9.2}Ce_{6.0}Pr_{0.2}Nd_{0.7}Zr_{0.3}Ni_{73.0}Mn_{5.9}Al_{4.6}) and a ErF₃ coating layer on the surface of the hydrogen storage alloy particles, and based on the mass of the negative electrode active material, the content of the coating layer is 3 wt %.

The difference between the preparation method for the negative electrode material in the present Example and the preparation method for the negative electrode material in Example 1 is only that each 1 g of the hydrogen storage alloy corresponds to 0.01 g of PVP, 0.05930 g of Er(NO₃)₃·5H₂O (MW=443.35 g/mol), and 0.01486 g of NH₄F.

### Example 4

The present Example provides a preparation method of half-cell for electrochemical testing. The difference between the half-cell provided by the present Example and the half-cell provided by Example 1 is only that the negative electrode material used in the present Example comprises the hydrogen storage alloy (La_{9.2}Ce_{6.0}Pr_{0.2}Nd_{0.7}Zr_{0.3}Ni_{73.0}Mn_{5.9}Al_{4.6}) and a NdF₃ coating layer on the surface of the hydrogen storage alloy particles, and based on the mass of the negative electrode material, the content of the coating layer is 2.5 wt %.

Preparation for the negative electrode material of the present Example includes the following steps:
In the first step, the hydrogen storage alloy, PVP (MW≈55000), NdCl₃·6H₂O (MW=358.69 g/mol), and NaF solution are weighed. It should be noted that each 1 g of the hydrogen storage alloy corresponds to 0.01 g of PVP and 0.04456 g of NdCl₃·6H₂O;
In the second step, PVP is dissolved in 10 ml of deionized water in a beaker and stirred for 10 minutes at 500 RPM to obtain Solution I;
In the third step, NdCl₃·6H₂O is dissolved in Solution I to obtain Solution II;
In the fourth step, NaF is dissolved in deionized water to obtain Solution III. Specifically, Solution III is a 0.5 M NaF solution, and each 1 g of the hydrogen storage alloy corresponds to 0.745 mL of Solution III;
In the fifth step, Solution II is heated to 75° C. using a hot plate and stirred at 300 RPM. The hydrogen storage alloy powder is immersed in Solution II to obtain Mixture I;
In the sixth step, Solution III is added into Mixture I drop by drop by a pipette to obtain Mixture II;
In the seventh step, Mixture II is continuously stirred at 75° C. for 2 hours to obtain a suspension. The suspension is centrifuged, and the powder separated is washed with deionized water for 3 times; and
In the eighth step, the washed powder is dried at 80° C. for 12 hours in vacuum, and then it is calcinated at 100° C. for 1 hour under an argon environment to obtain the negative electrode material.

### Example 5

The present Example provides a preparation method of half-cell for electrochemical testing. The difference between the half-cell provided by the present Example and the half-cell provided by Example 1 is only that the negative electrode material used in the present Example comprises the hydrogen storage alloy (La_{9.2}Ce_{6.0}Pr_{0.2}Nd_{0.7}Zr_{0.3}Ni_{73.0}Mn_{5.9}Al_{4.6}) and YbF₃ coating layer on the surface of the hydrogen storage alloy particles, and based on the mass of the negative electrode material, the content of the coating layer is 3.5 wt %.

The difference between the preparation method for the negative electrode material in the present Example and the preparation method for the negative electrode material in Example 1 is only that each 1 g of the hydrogen storage alloy corresponds to 0.01 g of PVP, 0.06833 g of Yb(NO₃)₃·5H₂O (MW=449.13 g/mol) and 0.01691 g of NH₄F.

### Example 6

Except that the hydrogen storage alloy surface is coated a LaF₃ coating layer (the mass ratio of the hydrogen storage alloy to its coating layer is 49:1), a nickel-metal hydride secondary battery is prepared with the same method as seen in Comparative Example 1.

### Example 7

Except that the hydrogen storage alloy surface is coated with a LaF₃ coating layer (the mass ratio of the hydrogen storage alloy to its coating layer is 24:1), a nickel-metal hydride secondary battery is prepared with the same method as seen in Comparative Example 1.

### Example 8

Except that the hydrogen storage alloy surface is coated with a NdF₃ coating layer (the mass ratio of the hydrogen storage alloy to its coating layer is 39:1), a nickel-metal hydride secondary battery is prepared with the same method as seen in Comparative Example 1.

### Example 9

Except that the hydrogen storage alloy surface is coated with a YbF₃ coating layer (the mass ratio of the hydrogen storage alloy to its coating layer is 96.5:3.5), a nickel-metal hydride secondary battery is prepared with the same method as seen in Comparative Example 1.

The half-cell provided by Comparative Example 2 and the half-cells provided by Examples 1-2 are subjected to the following tests with LANHE CT2001A battery test system.

[Charge/discharge cycling and high-rate discharge capability tests at room temperature]

Testing Steps Include:
Half-cell is charged at a current density of 300 mA/g for 100 minutes;
Half-cell is discharged at a current density of 900 mA/g until a cut-off voltage of 0.9 V is reached;
Half-cell is discharged at a current density of 600 mA/g until a cut-off voltage of 0.9 V is reached;
Half-cell is discharged at a current density of 300 mA/g until a cut-off voltage of 0.9 V is reached;
Half-cell is discharged at a current density of 200 mA/g until a cut-off voltage of 0.9 V is reached;
Half-cell is discharged at a current density of 100 mA/g until a cut-off voltage of 0.9 V is reached;
Half-cell is discharged at a current density of 60 mA/g until a cut-off voltage of 0.9 V is reached; and
Repeat the charge/discharge steps for 50 times.

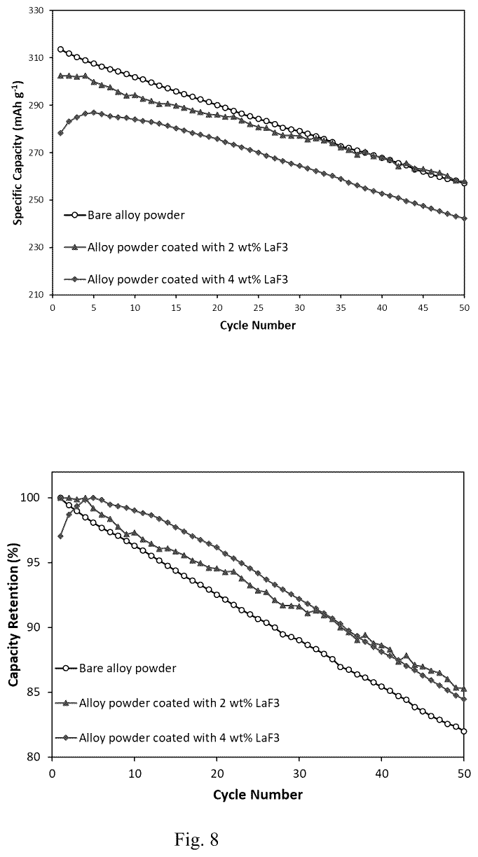

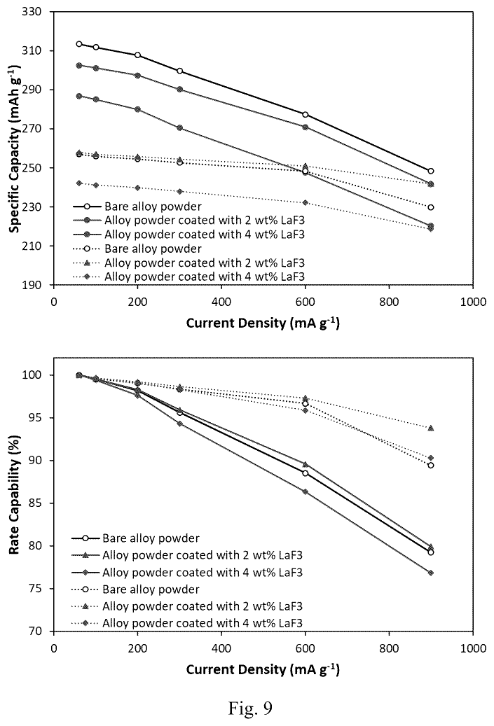

Cycling test results are shown in FIG. 8 and reveal that the half-cell of Example 2 has the best performance while the half-cell of Comparative Example 2 has the worst performance, demonstrating that the negative electrode material provided by the present invention can significantly improve the room-temperature cycling stability, and the degree of improvement is positively related to the content of the coating layer in the negative electrode material. However, due to the existence of the coating layer provided by the present invention, capacity is inevitably sacrificed, and therefore it is reasonable to set the content of the coating layer in the negative electrode material in the range of 2 wt %-4 wt %.

High-rate discharge capability results are shown in FIG. 9 and reveal that rate capability performances of all half-cells are improved after 50 charge/discharge cycles. However, discharge capacities of the half-cells of Examples 1-2 are unchanged at the highest rate after 50 charge/discharge cycles, but that of the half-cell of Comparative Example 2 decreases at the highest rate after 50 charge/discharge cycles. Therefore, the rate performance of the negative electrode material provided by the present invention is enhanced. Specifically, high-rate capacity is able to maintain stable at room temperature after several charge/discharge cycles.

The half-cell provided by Comparative Example 3, the half-cell provided by Comparative Example 4, and the half-cell provided by Example 2 are also subjected to charge/discharge cycling at room temperature. The test results show that nickel coating or fluorination treatment to the surface of the hydrogen storage alloy particles is not effective in improving the charge/discharge cycling stability at room temperature while the negative electrode material provided by the present invention can significantly improve the charge/discharge cycling stability at room temperature.

The negative electrode material of Comparative Example 2 and the negative electrode material of Example 2 are subjected to the following tests.

[Alkaline Washing Test at High Temperature]

Testing Steps Include:
0.25 g of negative electrode material is weighed;
The negative electrode materials are transferred to a 15 mL plastic vial;
12 mL of 30 wt % KOH solution is added into the vial, and the mixture is stirred;
The vial containing the mixture is placed in a DFZ-6020 oven (preheated to 100° C.) for 4 hours;
After 4 hours, the vial containing the mixture is taken out of the oven and cooled down to room temperature; and
From the vial, 10 mL of clear solution on top is transferred to a clean vial and saved for ICP analysis.

The ICP test results are shown in Table 1. Al and Mn detected in the alkaline wash solution are dissolved from the hydrogen storage alloy in the alkaline solution at high temperature. Therefore, lower traces of Al and Mn detected in the alkaline wash solution indicate that the negative electrode material has better stability at high temperature. As seen in Table 1, the coating layer of the negative electrode material provided by the present invention can significantly inhibit the dissolutions of Al and Mn from the hydrogen storage alloy in an alkaline solution at high temperature and therefore assists in achieving improved stability at high temperature.

TABLE 1

| | | Comparative | |
|---|---|---|---|
| | | Example 2 | Example 2 |
| Hot alkaline wash solution ICP | Al (ppm) | 5.87 | 2.45 |
| | Mn (ppm) | 0.7 | 0.17 |

[Electrochemical Test at High Temperature]

Testing Steps Include:
After activation, half-cell is charged at a current density of 100 mA/g for 5 hours;
Half-cell is placed in a DFZ-6020 oven (preheated to 50° C.);
Half-cell is kept in the oven for 72 hours;
Half-cell is taken out of the oven and cooled down to room temperature;
Half-cell is discharged at a current density of 100 mA/g until a cut-off voltage of 0.9 V is reached to rid the residual capacity;
Half-cell is charged at a current density of 100 mA/g for 5 hours;
Half-cell is discharged at a current density of 100 mA/g until a cut-off voltage of 0.9 V is reached; and
Repeat the steps above.

Results for electrochemical tests at high temperature are shown in Table 2 and reveal that the coating layer of the negative electrode material provided by the present invention can significantly improve the capacity recovery after storing the half-cell at high temperature, indicating its enhanced stability at high temperature.

TABLE 2

| | Comparative | |
|---|---|---|
| | Example 2 | Example 2 |
| Initial capacity at room temperature | 100% | 100% |
| After storing at high temperature once, | 88% | 96% |
| capacity recovery at room temperature | | |
| After storing at high temperature twice, | 86% | 96% |
| capacity recovery at room temperature | | |

Additionally, the present invention is not limited to the above-described Embodiments and Examples and may be variously changed. For example, the nickel-metal hydride secondary battery may be in a prismatic format, with no particular limitation on the mechanical structure.

Various technical features in Examples described above may be combined arbitrarily. In order to simplify the description, not all possible combinations of various technical features in the above-described Examples are described. However, as long as there is no contradiction in any combination of these technical features, all should be regarded as within the range recited in the present specification.

Examples described above only exhibit several Embodiments of the present invention, descriptions of which are more specific and detailed, but they cannot therefore be understood as limitation to the range of the present invention. It should be pointed out that, for those ordinary skilled in this field, some variants and improvements may also be made without departing from the conception of the present invention and all belong to the scope of protection of the present invention. Therefore, the scope of protection of the present invention should be determined by the appended claims.

1. A negative electrode material, comprising a hydrogen storage alloy and a coating layer on the surface of particles of the hydrogen storage alloy;
based on the mass of the negative electrode active material, the content of the coating layer is no less than 2 wt %; and the coating layer comprises a component shown by a general formula LnFₓ, Ln is at least one element selected from the group consisting of La, Ce, Pr, Nd, Pm, Sm, Eu, Gd, Tb, Dy, Ho, Er, Tm, Yb, Lu, Y, and Sc.

2. The negative electrode material according to claim 1, wherein the mass of the negative electrode active material, the content of the coating layer is 2 wt %-4 wt %.

3. The negative electrode material according to claim 1, wherein, the coating layer comprises LaF₃.

4. The negative electrode material according to claim 1, wherein, the hydrogen storage alloy is AB₅ type.

5. The negative electrode material according to claim 4, wherein, in a crystal structure of the hydrogen storage alloy, A site thereof contains X element, and B site thereof contains Ni element and Y element, X is at least one element selected from the group consisting of La, Ce, Pr, Nd, Pm, Sm, Eu, Gd, Tb, Dy, Ho, Er, Tm, Yb, Lu, Ca, Sr, Sc, Y, Ti, Zr, and Hf, and Y is at least one element selected from the group consisting of Mn, Co, V, Nb, Ta, Cr, Mo, Fe, Al, Ga, Zn, Sn, In, Cu, Si, P, and B.

6. The negative electrode material according to claim 5, wherein, the hydrogen storage alloy is La_{9.2}Ce_{6.0}Pr_{0.2}Nd_{0.7}Zr_{0.3}Ni_{73.0}Mn_{5.9}Al_{4.6}.

7. The negative electrode material according to claim 1, wherein, a thickness of the coating layer is 0.1-1000 nm.

8. A method for preparing the negative electrode material according to claim 1, wherein, the method includes the following steps:
a step of dissolving polyvinylpyrrolidone in deionized water to obtain a first solution;
a step of dissolving at least one salt containing an Ln element in the first solution to obtain a second solution;
a step of pre-dissolving an inorganic fluoride salt in deionized water to obtain a third solution;
a step of immersing a hydrogen storage alloy in the second solution to obtain a first mixture;
a step of adding the third solution into the first mixture to obtain a second mixture;
a step of subjecting the second mixture to a heating treatment to obtain a powder; and
a step of subjecting the powder to a drying treatment and then a calcining treatment.

9. The method according to claim 8, wherein, the inorganic fluoride salt is NH₄F or NaF.

10. A nickel-metal hydride secondary battery, comprising a container, and an electrode assembly contained in the container together with an alkaline electrolyte in a sealed state, wherein the electrode assembly is composed of a positive electrode and a negative electrode separated by a separator, and the negative electrode contains the negative electrode material according to claim 1.
